(19) United States
(12) Patent Application Publication
(10) Pub. No.: US 2001/0011354 A1
(43) Pub. Date: Aug. 2, 2001

(54) Information provision control system, information provision control method and recording medium thereof

(76) Inventors: Masayuki Inagaki, Tokyo (JP); Eiichi Yoshikawa, Tokyo (JP); Toshimitsu Ushijima, Tokyo (JP); Toshihiko Handa, Tokyo (JP); Masami Hayasi, Tokyo (JP); Osamu Mikami, Tokyo (JP)

Correspondence Address: SUGHRUE, MION, ZINN, MACPEAK & SEAS, 2100 Pennsylvania Avenue, N.W., Washington, DC, 20037-3202, US

(21) Appl. No.: 09/774,614

(22) Filed: Feb. 1, 2001

(30) Foreign Application Priority Data
Feb. 2, 2000 (JP) 2000-025615

(51) Int. Cl. G06F 12/14

(52) U.S. Cl. 713/201

(57) ABSTRACT

An information provision control system is provided whereby preferential information can be provided only to the employees of an affiliated enterprise, using an Internet home page. An authentication server stores the domain names of terminals of affiliated parties who are permitted to obtain information stored in a contents server. Moreover, the authentication server, when the contents server is accessed, compares the domain name of the accessed terminal with stored domain names of terminals of affiliated parties, and judges if the terminal is the terminal of an affiliated party. A member management server, in the case where the terminal is the terminal of the affiliated party, limits the range of information to be provided according to the affiliated party.

### BACKGROUND OF THE INVENTION

1. Field of the Invention

The present invention relates to an information provision control system and an information provision control method which use the Internet, and a recording medium storing the program.

2. Description of the Related Art

General businesses or corporations (for example financial institutions such as banks) give various privileges to employees of specific customer enterprises (hereunder affiliated enterprises) with which a contract has been previously made, corresponding to their credit worthiness and the like. Here, “privileges” are for example where the employees of an affiliated enterprise of a bank are given low interest housing loans or the like. Furthermore, general businesses or corporations (for example financial institutions such as banks) perform many transactions and business operations using these privileges. Heretofore, information concerning such privileges etc. (hereunder preferential information) was made known to the employees of the affiliated enterprise by pamphlets, circulars and the like.

In the case of disclosing information by an Internet home page, updating etc. of the information can be easily carried out. Moreover, on the information acquiring side also, the latest information can be easily acquired.

However, when the information is published using the Internet home page, there is the disadvantage that the information is published even to those to whom publication is not desired.

Accordingly, if preferential information is published on the Internet home page, updating of the information is easily performed, however at the same time the preferential information is also published to other business enterprises. For the enterprise, it is desired that this preferential information is not leaked to other business enterprises. This is because preferences differ for each of the various affiliated enterprises. As a precaution against this, there is also a method where a special URL is set. However if the employee of the affiliated enterprise learns of this URL even after retirement, there is the possibility of violation, with the likelihood of information then being leaked.

Therefore, heretofore preferential information was only made known to employees of the affiliated enterprise by the method as mentioned above involving pamphlets and circulars etc., and making known using an Internet home page was not possible.

### SUMMARY OF THE INVENTION

The present invention takes into consideration the above situation, with the object of providing an information provision control system whereby preferential information can be provided only to the employees of an affiliated enterprise, using an Internet home page.

In order to achieve the above object, the present invention is an information provision control system which when accessed via the Internet, provides as a response information stored on a contents server, and comprises; an authentication domain name storage device for storing a domain name or IP address (Internet protocol address) of a terminal of an affiliated party who is permitted to obtain the information stored on the contents server, an authentication domain name judgment device for examining the domain name or the IP address (Internet protocol address) of a terminal which has gained access, comparing the domain name or the IP address (Internet protocol address) with the domain name or the IP address (Internet protocol address) of the terminal of the affiliated party which is stored in the authentication domain name storage device, and judging if the terminal is the terminal of the affiliated party, and a member management server which, in the case where the terminal is the terminal of the affiliated party, limits the range of information to be provided according to the affiliated party.

By having the abovementioned construction, it is possible to judge from the domain name or the IP address (Internet protocol address) of the terminal gaining access, if the terminal gaining access is that of the affiliated party. Therefore preferential information can be provided to only the employees of the affiliated enterprise. Furthermore, the latest information can be read at all times, detailed information corresponding to user groups can be provided to a plurality of user groups, and updating of the contents can be easily performed.

The present invention is an information provision control system which when accessed via the Internet, provides as a response information stored on a contents server, and comprises; an authentication identification number storage device for storing an identification number which a member who is permitted to obtain information stored in the contents server has, an authentication identification number judgment device for examining the identification number which is input at the time of provider connection or at the time of the contents server connection, comparing the identification number with the identification number of the member stored in the authentication identification number storage device, and judging if the person who has accessed the contents server is the member, and a member management server which, in the case where the person who has gained access is a member, limits the range of information to be provided according to the member.

By having the abovementioned construction, the identification number is read in when the terminal gaining access is connected to the provider, or when this is connected to the contents server. Hence, it is possible to judge if the terminal which has gained access is that of the member. Therefore preferential information can be provided to only the employee of the affiliated enterprise. Furthermore, the latest information can be read at all times, detailed information corresponding to user groups can be provided to a plurality of user groups, and updating of the contents can be easily performed.

With the present invention, in the abovementioned information provision control system, this further has an access control device for limiting access to the contents server, depending on time or connection environment.

The present invention is characterized in that in the information provision control system the contents server further has; a contents configuration components filing device for individually filing frame data or text data or image file data (for example, GIF data) constituting the contents, and a dynamic contents creation function device for creating contents wherein the frame data or the text data or the image file data filed by the contents configuration component filing device, is rearranged according to the member who has accessed the contents server.

The present invention is characterized in that in the information provision control system, the member management server further has a member retrieval device for retrieving the member who satisfies conditions which have been input, and a mail transmission device for transmitting mail to the member who has been retrieved by the member retrieval device.

The present invention is characterized in that the information provision control system further has an information provision device for providing information to the member, and an information management device for setting according to the member, a right to refer to the information, a right to update the information, and a right to delete the information.

The present invention provides an information provision control method for executing the abovementioned information control system, and a computer readable recording medium recorded with a program for executing this on a computer.

### BRIEF DESCRIPTION OF THE DRAWINGS

FIG. 1 is a block diagram showing the configuration of an information provision control system according to an embodiment of the present invention.

FIG. 2 is an explanatory diagram for the case where the information provision control system of FIG. 1 controls access by connection environment and access time.

FIG. 3 is an explanatory diagram for the case where a joining application is made to become a member of a bank A.

FIG. 4 is an explanatory diagram for the case of registration or updating of members of the bank A.

FIG. 5 is an explanatory diagram for the case of performing admittance management for members of the bank A.

FIG. 6 is an explanatory diagram for the case where the information provision control system of FIG. 1 authenticates members from domain names.

FIG. 7 is an explanatory diagram for the case where the information provision control system of FIG. 1 authenticates members by IDs used for connection to a provider 100.

FIG. 8 is an explanatory diagram for the case where mail is sent using the information provision control system shown in FIG. 1.

FIG. 9 is an explanatory diagram of a bulletin board function in the information provision control system of FIG. 1.

FIG. 10 is an explanatory diagram for the case where the information provision control system of FIG. 1 performs updating and information provision of contents.

FIG. 11 is an explanatory diagram for the case where the information provision control system of FIG. 1 generates dynamic contents.

FIG. 12 is a flow chart showing the flow of the present invention.

### DESCRIPTION OF THE PREFERRED EMBODIMENTS

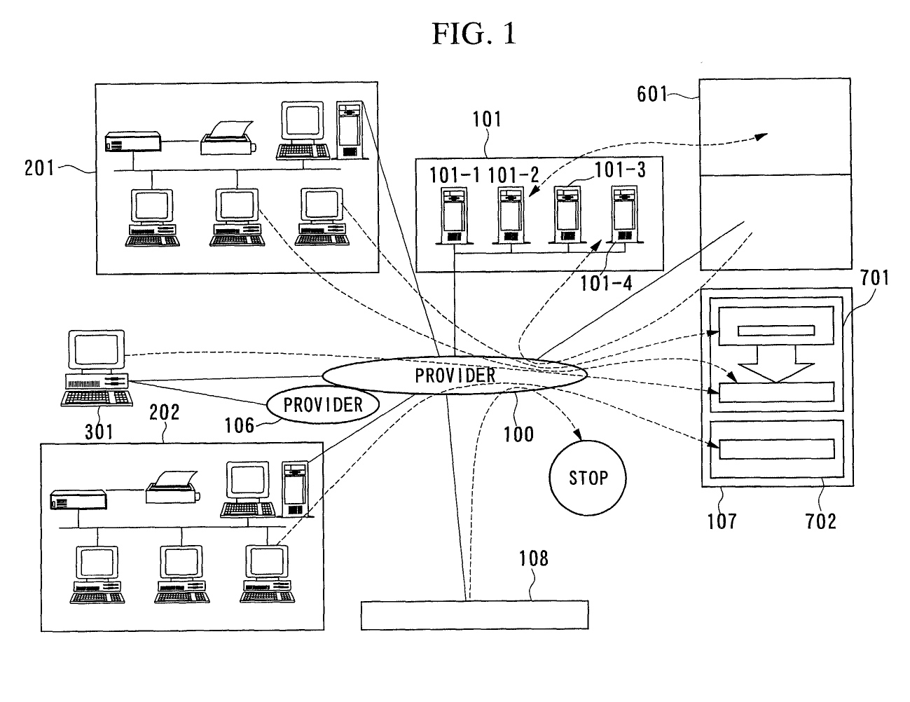

FIG. 1 is a block diagram showing the configuration of an information provision control system according to an embodiment of the present invention, and a server and terminals for connecting this to a network. In FIG. 1, reference symbols 100 and 106 denote providers. In order to connect to the provider 100 or 106, it is necessary to input an ID and password given at the time of a contract. Reference symbol 101 denotes a network operation center (referred to hereunder as NOC) of a provider comprising an authentication server 101-1, a member management server 101-2, an access control server 101-3, and a contents server 101-4.

The authentication server 101-1 performs authentication of the ID and password of the provider 100 input by the user, or authentication of the member number and the member password which are registered at the time of joining. Furthermore, the authentication server 101-1 performs authentication from the domain name of the other party who has gained access, as to whether or not the terminal of the other party who has gained access is that of an affiliated enterprise.

The member management server 101-2 stores decided information which can be provided to each member, and restricts access to information which cannot be provided to a member. Furthermore, the member management server 101-2, in the case of strengthening security, is provided with a function for encoding the stored information by an SSL (Secure Sockets Layer (details omitted)).

The access control server 101-3 limits access to the contents server 101-4 by connection environment or access time. Here “connection environment” is the route taken in order to connect the terminal which has gained access, to the provider. Furthermore, access time is the time at which the contents server 101-4 is accessed.

The contents server 101-4, when accessed, under instructions from the authentication server 101-1, and the access control server 101-3, reads out to the member management server 101-2 from the memory 107 specified information, and provides this to the other party who has gained access.

Reference symbol 107 denotes a memory inside the contents server 101-4. Here a bank A is contracted with a provider 100 which manages the network operation center 101. Reference symbol 108 denotes a terminal unit of an enterprise or individual other than the affiliated enterprise. Reference symbols 201 and 202 denote affiliated enterprises of the bank A. The terminals inside these affiliated enterprises are connected to the network via the provider 100. Reference symbol 301 denotes a terminal at the home or the like of an employee of the affiliated enterprise 201 for which the members are registered with the bank A. Reference symbol 601 denotes a management terminal for performing management of the members of the bank A, and management of the information which the bank A supplies. Reference symbol 701 denotes information of the bank A which can be acquired by the terminal operated by the employees of the affiliated enterprise 201. Reference symbol 702 denotes information of the bank A which can be acquired by the terminal operated by the employees of the affiliated enterprise 202.

Here the information provision control system comprises; the authentication server 101-1, the member management server 101-2, the access control server 101-3 and the contents server 101-4.

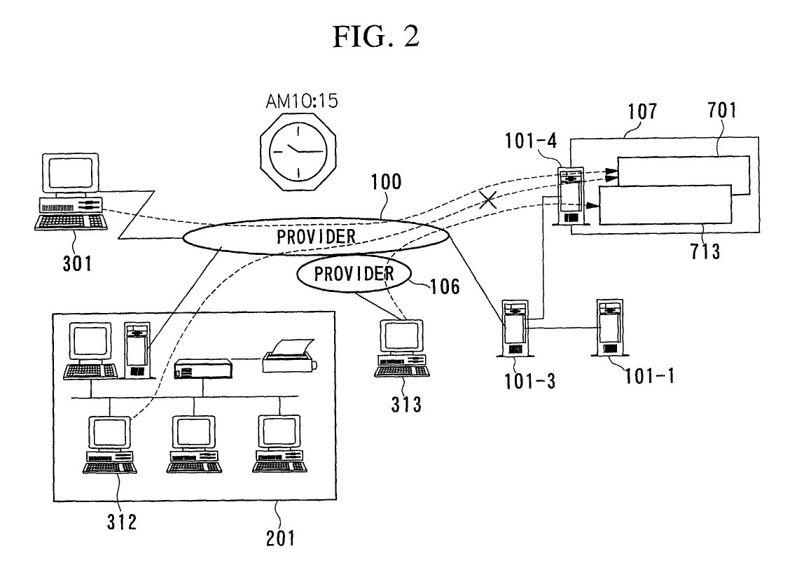

Next is a description of the operation of the information provision control system shown in FIG. 1, with reference to FIG. 2.

FIG. 2 is an explanatory diagram for the case where the information provision control system of FIG. 1 controls access by connection environment and access time. In this figure, the terminals etc. corresponding to those of FIG. 1 are denoted by the same reference symbols, and description is omitted. Moreover, in this figure, reference symbols 312 and 313 denote member terminals. Here terminal 312 is inside the affiliated enterprise 201 of the bank A. Furthermore, terminal 313 is contracted with the provider 106. Reference symbol 713 denotes information of the bank A which the terminal 313 can acquire.

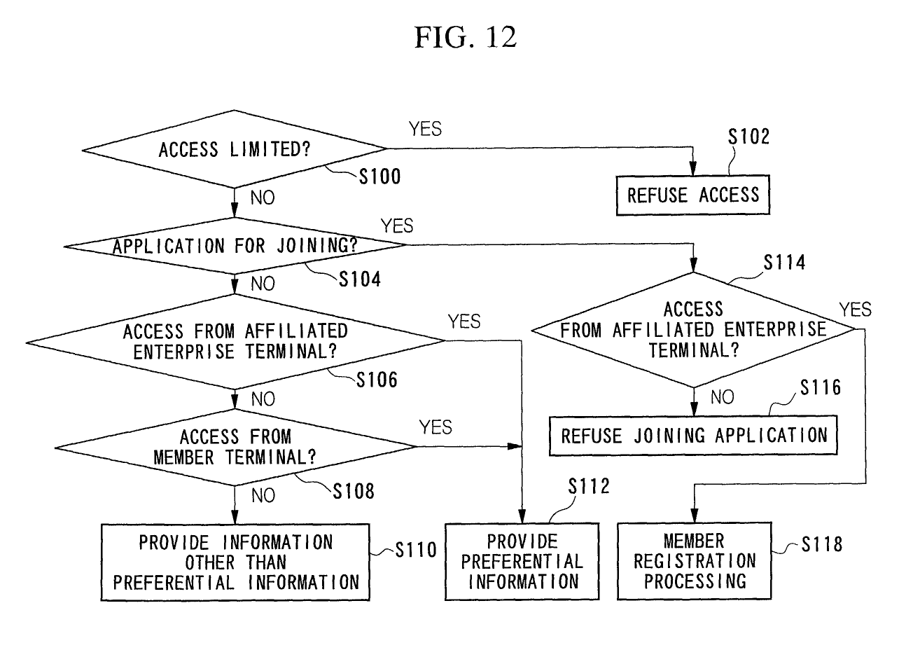

When the NOC 101 (refer to FIG. 1) is accessed, the access control server 101-3 examines the connection environment of the terminal which has gained access and the time when this terminal accesses the NOC 101, compares this with information stored thereinside, and judges whether or not to limit the access from this terminal to the contents server 101-4 (step S100 in FIG. 12). In the case where the comparison results are such that the access control server 101-3 judges that access from that terminal to the contents server 101-4 should be limited, the contents server 101-4 refuses access from that terminal (step S102 in FIG. 12). The time when access is possible within the same affiliated enterprise can also be multiply set.

For example, in the case where a member being an employee of the affiliated enterprise 201 makes a dialup connection, they can access the contents server 101-4 at all times, while with other connection methods, they can only access the contents server 101-4 from 12 pm to 1 pm, or from 5 pm to 9 am.

At 10:15 am, the terminal 301 can access the contents server 101-4, while the terminal 312 cannot access the contents server 101-4.

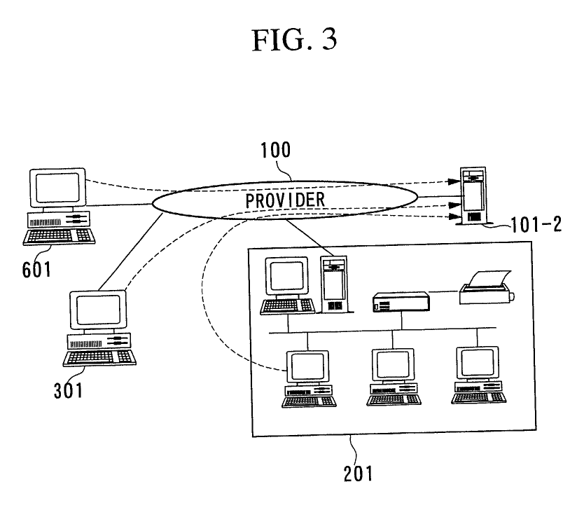

FIG. 3 is an explanatory diagram for the case where joining application is made to become a member of the bank A. In this figure, the terminals etc. corresponding to those of FIG. 1 and FIG. 2 are denoted by the same reference symbols, and description is omitted.

When the NOC 101 (refer to FIG. 1) is accessed, the member management server 101-2 judges if that access is an application for joining (step S104 of FIG. 12). If the member management server 101-2 judges that the access is an application for joining, the authentication server 101-1 performs authentication as to whether or not the terminal of the other party who has gained access is the terminal of an affiliated enterprise, from the domain name of the terminal which has gained access (step S114 of FIG. 12).

In the case where the authentication server 101-1 judges that the terminal which has gained access is not the terminal of an affiliated enterprise, the member management server 101-2 refuses the joining application (step S116 of FIG. 12).

In the case where the terminal which has gained access is a terminal of an affiliated enterprise, the member management server 101-2 sends mail to the effect that there is a joining application, to the manager of the bank A.

If the manager of the bank A makes an acceptance with respect to the joining application, the flow proceeds to member registration processing (step S118 in FIG. 12). In this member registration processing, the member profile, member number, member password etc. are registered. Changing of the member password can be performed from the member terminal rather than from the terminal of the manager of the bank A.

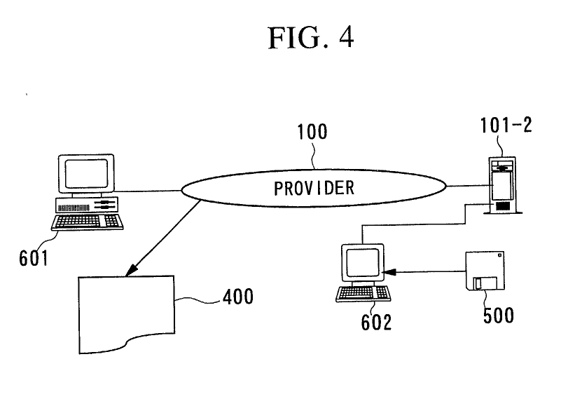

FIG. 4 is an explanatory diagram for the case of registration or updating of members of the bank A. In this figure, the terminals etc. corresponding to those of FIG. 1 through FIG. 3 are denoted by the same reference symbols, and description is omitted. Moreover, in this figure, reference symbol 400 denotes a printer. Reference symbol 500 denotes information such as the profile of an employee of the affiliated enterprise. Reference symbol 602 denotes a terminal inside the bank A, for input of information 500.

The method whereby the manager of the bank A performs registration and updating of the members involves; a method of accessing the NOC 101 (refer to FIG. 1) from the management terminal 610, connecting to the member management server 101-2, and inputting for each piece of the information, and a method of processing inside the bank A the information 500 which has been delivered from the affiliated enterprise, and inputting the processed informaiton in a lump using the terminal 602.

The information which the manager of the bank A registers, is information such as the profile of the member, and the information which the member can acquire. Furthermore, other than this, optional items can also be added.

The manager of the bank A can download registered member information at the management terminal 610, and can also perform processing with separate optional tools. Furthermore, the manager of the bank A can retrieve any members from registered member information. Moreover, the manager of the bank A can make separate groups for each employee, and register this.

Next is a description of the groups.

(1) Static group

This is a group which is created by the manager of the bank A.

(2) Dynamic group

This is a group comprising members who satisfy conditions input by the manager of the bank A. Creation of this group is performed automatically by the member management server 101-2. Furthermore, this group is reviewed automatically once each day and updated.

(3) Group updating and deleting

The manager of the bank A can delete a created group, and can update condition settings of a dynamic group. Here even if a group is deleted, the members belonging to that group are not necessarily withdrawn.

(4) Addition and deletion of members belonging to a group

The manager of the bank A can delete or add members belonging to a group irrespective of the group being a static group or a dynamic group.

(5) Mail

The manager of the bank A can send mail having the same contents, to members belonging to a group. This mail, can be send simultaneously to a maximum of 999 names.

(6) Contents access rights setting

The manager of the bank A can control information which can be accessed, for each group.

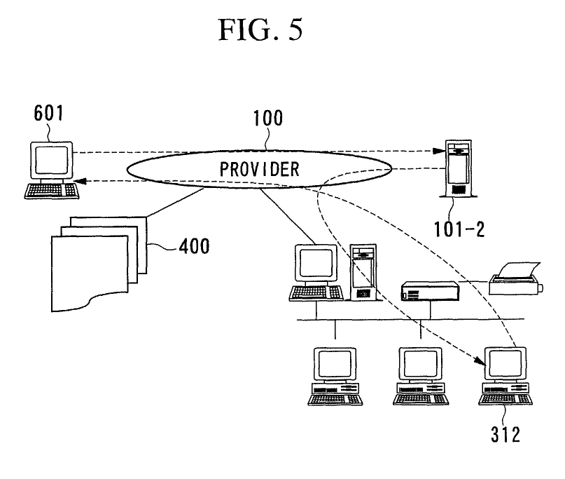

FIG. 5 is an explanatory diagram for the case of performing admittance management for members of the bank A. In this figure, terminals etc. corresponding to those of FIG. 1 through FIG. 4 are denoted by the same reference symbols, and description is omitted.

The manager of the bank A issues member certificates giving registration date, member number and the like, to people who have been registered as members. Moreover, at this time member registration is also advised concurrently by electronic mail.

The manager of the bank A can periodically (for example once a month) ascertain from the use history, the use state of a member as withdrawal promotion processing, and send mail for urging withdrawal, to members who do not make access for a fixed period (for example six months).

In the case where there is no reply to this mail, the next month the member management server 101-2 automatically deletes this member. In the case where there is a request for continued registration, the manager of the bank A performs processing to stop the automatic deletion.

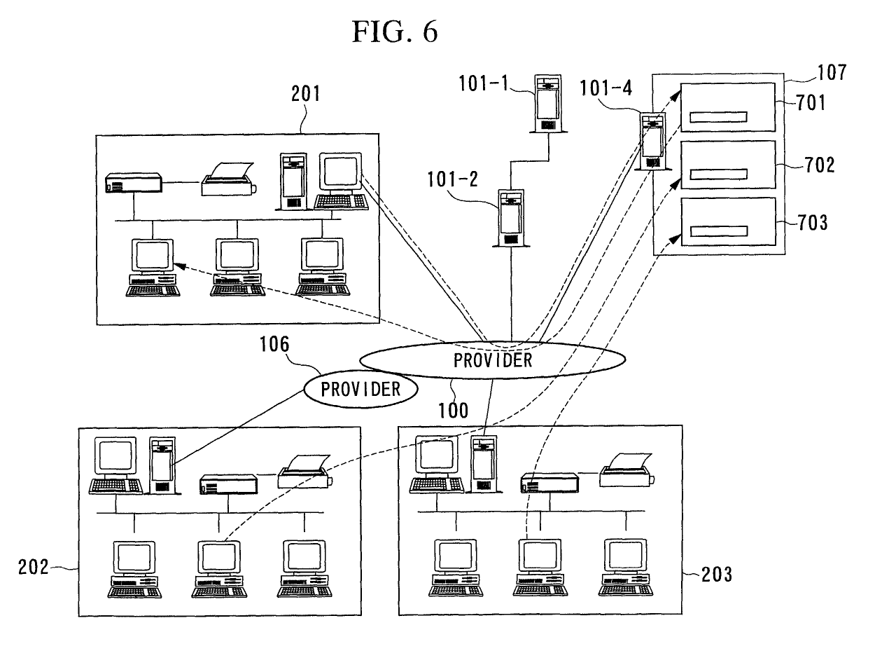

FIG. 6 is an explanatory diagram for the case where the information provision control system of FIG. 1 authenticates the affiliated enterprise from domain names. In this figure, the terminals etc. corresponding to those of FIG. 1 through FIG. 5 are denoted by the same reference symbols, and description is omitted. Moreover, in this figure, reference symbol 203 denotes an enterprise which is not an affiliated enterprise of the bank A. Reference symbol 703 denotes information of the bank A which a terminal operated by a person other than an employee of the member enterprise can acquire.

In step S104 of FIG. 12, when the member management server 101-2 judges that the access is not for a joining application, the authentication server 101-1 performs authentication from the domain name of the terminal gaining access, as to whether or not the terminal gaining access is a terminal of an affiliated enterprise (step S106 in FIG. 12).

In the case where the terminal of the other party who has gained access is the terminal of an affiliated enterprise, the contents server 101-4 provides preferential information to the affiliated enterprise to which the operator of the terminal belongs (step S112 in FIG. 12). As a result, preferential information can be supplied to the employee of the affiliated enterprise.

For example, in the case where the NOC 101 (refer to FIG. 1) is accessed from a terminal inside the affiliated enterprise 201, information 701 is supplied to this terminal. Furthermore, if accessed from a terminal which is outside of the affiliated enterprise 201, as with a terminal inside the enterprise 203, information 703 is supplied to that terminal.

With this embodiment, affiliated enterprises are authenticated by domain name. However the configuration may be such that affiliated enterprise are authenticated by IP address (Internet protocol address).

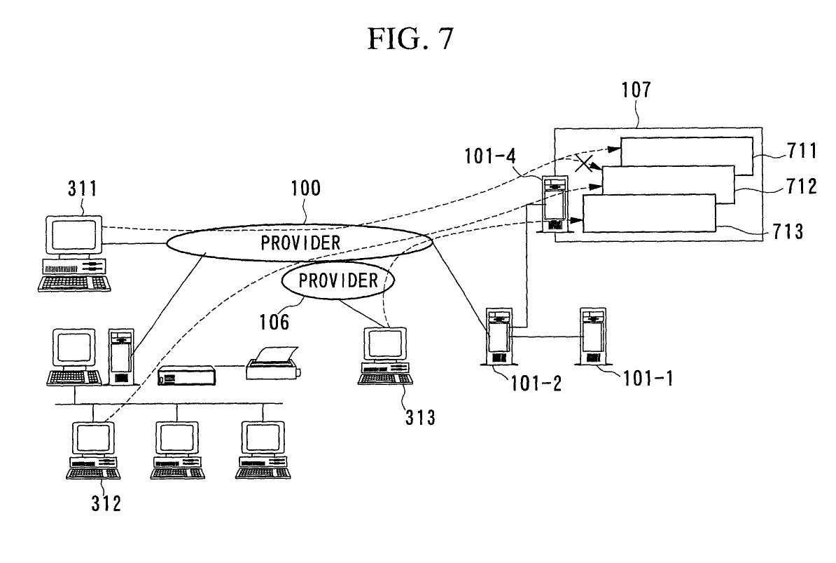

FIG. 7 is an explanatory diagram for the case where the information provision control system of FIG. 1 authenticates members by IDs used for connection to a provider 100. In this figure, the terminals etc. corresponding to those of FIG. 1 through FIG. 6 are denoted by the same reference symbols, and description is omitted. Moreover, in this figure, reference symbol 311 denotes a member terminal. Reference symbol 711 denotes information of the bank A which the terminal 311 can acquire. Reference symbol 712 denotes information of the bank A which the terminal 312 can acquire.

In step S106 of FIG. 12, in the case where the authentication server 101-1 judges that the terminal which has gained access is not a terminal of an affiliated enterprise, the authentication server 101-1 detects the ID and password at the time when the terminal which has gained access is connected to the provider 100, and authenticates whether or not the terminal which has gained access is a member terminal (step S108 in FIG. 12). If from the result it is understood that the terminal which has gained access is a member terminal, the member management server 101-2 prescribes the information which can be provided, according to the ID and password of the authenticated member, and instructs this to the contents server 101-4.

The contents server 101-4, under the instructions from the member management server 101-2, then provides the preferential information to the terminal which has gained access (step S112 in FIG. 12).

For example, in the case where the NOC 101 (refer to FIG. 1) is accessed from the terminal 311, the member control server limits the information which the terminal 311 can acquire, to the information 711 only. The contents server 101-4 under these instructions then provides the information 711 to the terminal 311.

Furthermore, in the case where the NOC 101 is accessed from a terminal which is not contracted with the provider 100, the member management server 101-2 requests a previously registered member number and member password. The authentication server 101-1 then authenticates from the input member number and member password, whether or not the terminal which has gained access is a member terminal (step S108 in FIG. 12). If from the result it is understood that the terminal which has gained access is a member terminal, the member management server 101-2 prescribes the information which can be provided, according to the authenticated member number and member password, and instructs this to the contents server 101-4. The contents server 101-4, under the instructions from the member management server 101-2, then provides the preferential information to the person gaining access.

For example, in the case where the NOC 101 is accessed from the terminal 313, the member control server limits the information which the terminal 313 can acquire, to information 713 only. The contents server 101-4 under these instructions then provides the information 711 to the terminal 313.

Moreover, in the case where the member management server 101-2 has security further strengthened, encoding can be performed using SSL (Secure Sockets Layer (details omitted)).

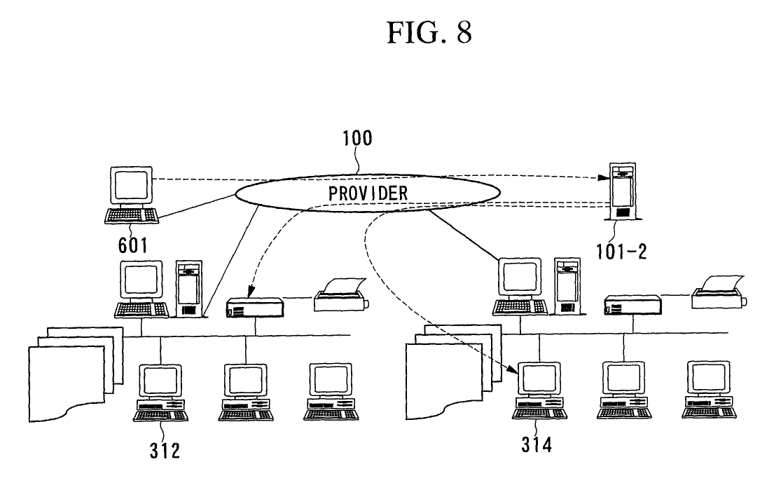

FIG. 8 is an explanatory diagram for the case where mail is sent using the information provision control system of FIG. 1. In this figure, the terminals etc. corresponding to those of FIG. 1 through FIG. 7 are denoted by the same reference symbols, and description is omitted. Moreover, in this figure, reference symbol 314 denotes a member terminal.

The manager of the bank A, in the case of sending mail, selects members to which mail is sent, from information of registered members, and performs simultaneous transmission to mail addresses which have been specified at the time of member registration using a dedicated form. The destination address is automatically acquired from the target member information, so that input by the manager of the bank A is not required.

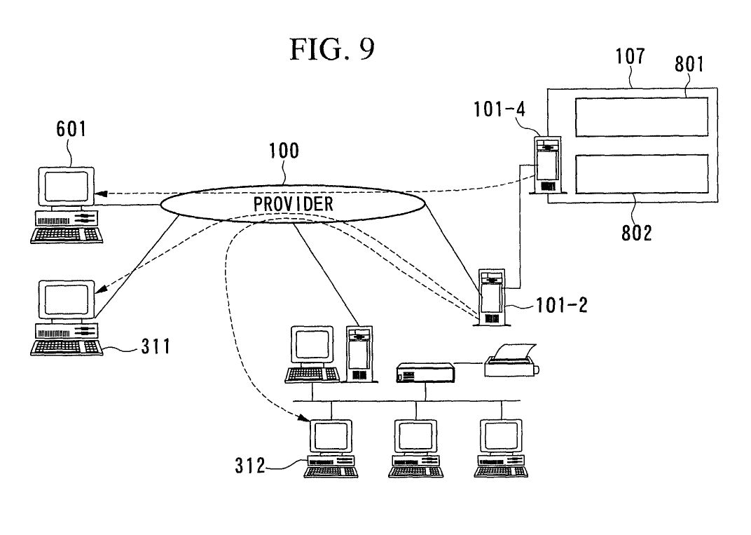

FIG. 9 is an explanatory diagram of a bulletin board function in the information provision control system of FIG. 1. In this figure, the terminals etc. corresponding to those of FIG. 1 through FIG. 8 are denoted by the same reference symbols, and description is omitted. Moreover, in this figure, reference symbols 801 and 802 denote bulletin boards whereby members can exchange information.

The manager of the bank A can make settings of the bulletin board. Moreover, the manager can set the bulletin board access rights, reference rights, updating rights, and deletion rights for each member.

An employee of an affiliated enterprise can contribute new articles to the bulletin board to which they have updating rights. Irrespective of the settings for the article deletion rights, articles which have been contributed by oneself can be deleted. Members who are not given deletion rights cannot delete articles contributed by another person. Since the articles written to the bulletin board are backed up, it is possible to recover these even in the case where articles are erroneously deleted.

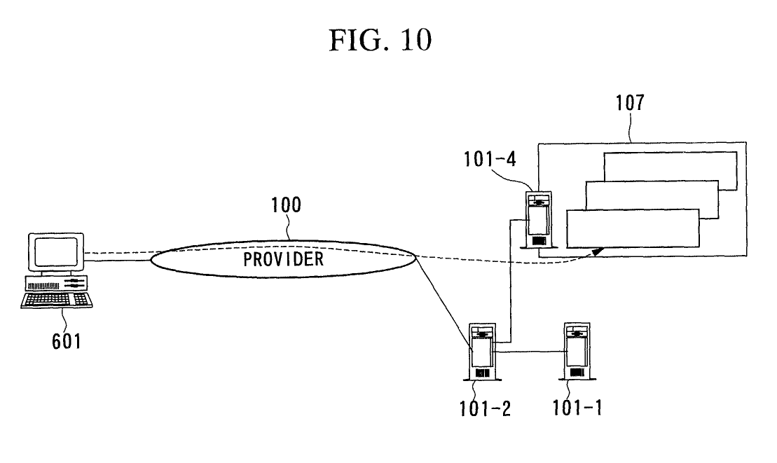

FIG. 10 is an explanatory diagram for the case where the information provision control system of FIG. 1 performs updating and information provision of the contents. In this figure, the terminals etc. corresponding to those of FIG. 1 through FIG. 9 are denoted by the same reference symbols, and description is omitted.

The bank A prepares a dedicated environment inside the NOC 101 (refer to FIG. 1) of the provider. The created contents are connected by dialing up from a terminal inside the bank A, and the contents are updated by file transfer. Inside the provider is constructed by a high speed (for example 100 Mbps) network (for example a LAN environment), so that a response can be made at an optimum response with respect to a large number of accesses. In the case where the contents server 101-4 is installed in the bank A, a dedicated circuit corresponding to access is required, and by installing this inside the NOC, cost increases can be kept down.

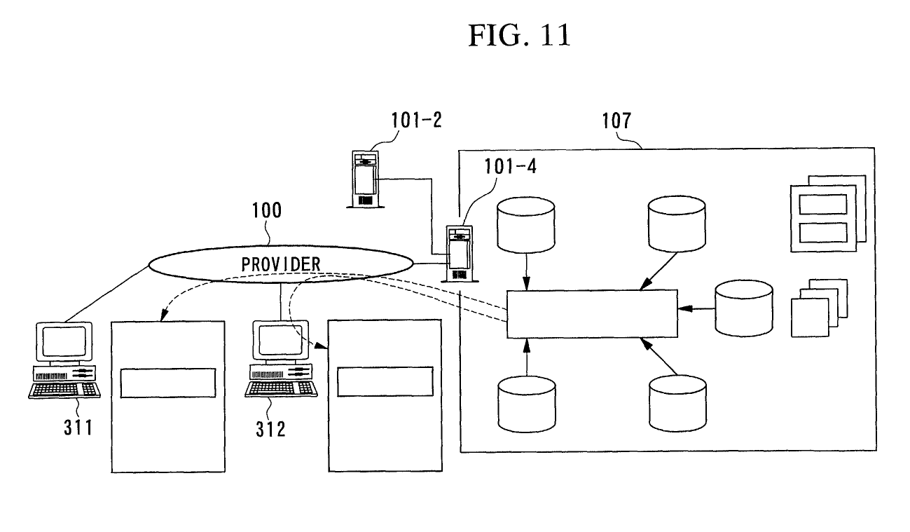

FIG. 11 is an explanatory diagram for the case where the information provision control system of FIG. 1 generates dynamic contents. In this figure, the terminals etc. corresponding to those of FIG. 1 through FIG. 10 are denoted by the same reference symbols, and description is omitted.

In the case where the preferential information differs for each affiliated enterprise, it is necessary to prepare and update the contents for each. However with the increase in the affiliated enterprises, maintenance updating becomes difficult. In order to prevent this, this has a function for separately filing the parts (frame data, text data, image file data such as GIF file data etc.) constituting the contents, and when there is access from a user, specifying the affiliated enterprise from the member profile and performing construction dynamically in accordance with the contents registered in the contents configuration database, and then displaying on the user terminal.

As a result, management of contents which differ depending on the affiliated enterprise is simplified. At the same time, it is possible to reduce the contents memory region.

Furthermore, a program for realizing the functions of the NOC in FIG. 1 may be recorded on a computer readable recording medium, and control performed by reading into a computer system and executing the program recorded on this recording medium. Here “computer system” also includes the operating system and hardware such as peripheral devices.

Furthermore, “computer system” in the case where a WWW (World Wide Web) system is used, also includes a home page provision environment (or display environment).

Moreover, “computer readable recording medium” refers to portable media such as floppy discs, magneto-optical discs, ROM, CD-ROM, and storage devices such as hard disks built into the computer system. Furthermore, “computer readable storage medium” also includes media which holds a fixed time program such as a volatile memory (RAM) inside a computer system which becomes a server or a client in the case where a program is sent via a network such as the Internet or a communication line such as a telephone line.

Furthermore, the abovementioned program, may be transmitted to another computer system from the computer system where this program is stored on a storage device or the like, via a transmission media, or by transmission waves within the transmission media. Here, “transmission media” for transmitting a program means a media having a function of transmitting information as with a network (communication network) such as the Internet or a communication circuit (communication line) such as a telephone line.

Moreover, the abovementioned program may be one for realizing a part of the abovementioned functions. Furthermore, this may be one where the abovementioned functions can be realized by combination with a program already recorded in a computer system, being a so called differential file (differential program).

Embodiments of the present invention have been described in detail above with reference to the drawings. However the present invention not only includes the abovementioned embodiments but of course also includes designs and modifications of a scope which does not depart from the gist of the present invention.

According to the present invention, an information provision control system which when a contents server on the Internet is accessed, obtains information as a response, comprises; an authentication domain name storage device for storing the domain name of a terminal of an affiliated party who is permitted to obtain the information stored on the contents server, an authentication domain name judgment device for, when the contents server is accessed, comparing the domain name of the accessed terminal, with the domain name of the terminal of the affiliated party which is stored in the authentication domain name storage device, and judging if the terminal is the terminal of the affiliated party, and a member management server which, in the case where the terminal is the terminal of the affiliated party, limits the range of information to be provided according to the affiliated party. Therefore, the effect is obtained where preferential information can be provided to only the employees of an affiliated enterprise.

Furthermore, it is also possible to obtain the effect that the latest information can be read at all times, the effect that detailed information corresponding to user groups can be provided to a plurality of user groups, and the effect that updating of the contents can be easily performed.

1. An information provision control system which when accessed via the Internet, provides as a response information stored on a contents server, comprising:
an authentication domain name storage device which stores domain names or IP addresses of terminals belonging to an affiliated party who is permitted to obtain the information stored on said contents server;
an authentication domain name judgment device which examines domain name or IP address of a terminal which has gained access, compares said domain name or said IP address with said domain name or said IP address of the terminal of said affiliated party which is stored in said authentication domain name storage device, and judges if said terminal is the terminal of said affiliated party; and
a member management server which, in the case where said terminal is the terminal of said affiliated party, limits the range of information to be provided according to said affiliated party.

2. An information provision control system according to claim 1, further comprising an access control device which limits access to said contents server depending on connection time or connection environment.

3. An information provision control system according to claim 1, wherein said contents server further comprises:
a contents configuration components filing device which individually files frame data or text data or image file data constituting the contents; and
a dynamic contents creation function device which creates contents wherein the frame data or the text data or the image file data filed by said contents configuration component filing device, is rearranged according to said member who has accessed said contents server.

4. An information provision control system according to claim 1, wherein said member management server further comprises:
a member retrieval device which retrieves members who satisfy conditions which have been input; and
a mail transmission device which transmits E-mails to said members who have been retrieved by said member retrieval device.

5. An information provision control system according to claim 1, further comprising:
an information provision device which provides information to members; and
an information management device which sets, according to said member, at least one of a right to refer to said information, a right to update said information, and a right to delete said information.

6. An information provision control system which when accessed via the Internet, provides as a response information stored on a contents server, comprising:
an authentication identification number storage device which stores identification numbers which members who are permitted to obtain information stored in said contents server have;
an authentication identification number judgment device which examines identification number which is input at the time of provider connection or at the time of connection to said contents server, compares said identification number with said identification numbers of said member stored in said authentication identification number storage device, and judging if the person who has accessed said contents server is one of said members, and
a member management server which, in the case where the person who has gained access is a member, limits the range of information to be provided according to said member.

7. An information provision control system according to claim 6, further comprising an access control device which limits access to said contents server depending on connection time or connection environment.

8. An information provision control system according to claim 6, wherein said contents server further comprises:
a contents configuration components filing device which individually files frame data or text data or image file data constituting the contents; and
a dynamic contents creation function device which creates contents wherein the frame data or the text data or the image file data filed by said contents configuration component filing device, is rearranged according to said member who has accessed said contents server.

9. An information provision control system according to claim 6, wherein said member management server further comprises:
a member retrieval device which retrieves members who satisfy conditions which have been input; and
a mail transmission device which transmits E-mails to said members who have been retrieved by said member retrieval device.

10. An information provision control system according to claim 6, further comprising:
an information provision device which provides information to members; and
an information management device which sets, according to said member, at least one of a right to refer to said information, a right to update said information, and a right to delete said information.

11. An information provision control method which at the time of access via the Internet, provides as a response information stored on a contents server, comprising:
a first step of, when said information provision control system is accessed, examining a domain name or IP address of the terminal which has gained access, and judging if said terminal is a terminal belonging to an affiliated party; and
a second step of, in the case where said terminal is the terminal belonging to said affiliated party, providing information decided according to said affiliated party.

12. An information provision control method which at the time of access via the Internet, provides as a response information stored on a contents server, comprising:
a first step of, when said contents server is accessed, examining an identification number which is read in at the time of provider connection or at the time of connection to said contents server, and judging if the person who has accessed said contents server is one of members; and
a second step of, in the case where the person who has gained access is one of said members, providing information decided according to said members.

13. A computer readable recording medium recorded with a program for at the time of access via the Internet, providing as a response information stored on a contents server, wherein said program executes on a computer:
a function for storing domain names or IP addresses of terminals belonging to an affiliated party who is permitted to obtain the information stored on said contents server;
a function for, when said contents server is accessed, comparing said domain name or said IP address of the terminal which has gained access, with said domain name or said IP address of the terminal of said affiliated party which is stored, and judging if said terminal is one of said terminals belonging to said affiliated party; and
a function for, in the case where said terminal is one of said terminals belonging to said affiliated party, limiting the range of information to be provided according to said affiliated party.

14. A computer readable recording medium recorded with a program for at the time of access via the Internet, providing as a response information stored on a contents server, wherein said program executes on a computer:
a function for storing identification numbers which members who are permitted to obtain information stored in said contents server have;
a function for when said contents server is accessed, comparing an identification number which is read in at the time of provider connection or at the time of said contents server connection, with said identification numbers of said members which are stored, and judging if the person who has accessed said contents server is one of said members; and
a function for, in the case where the person who has gained access is a member, limiting the range of information to be provided according to said member.
